(19) United States
(12) Patent Application Publication
(10) Pub. No.: US 2009/0188603 A1
(43) Pub. Date: Jul. 30, 2009

(54) METHOD AND APPARATUS FOR CONTROLLING LAMINATOR TEMPERATURE ON A SOLAR CELL

(75) Inventors: Uwe P. Haller, San Jose, CA (US); Yacov Elgar, Sunnyvale, CA (US); Thomas Klug, Grossostheim (DE)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/359,250

(22) Filed: Jan. 23, 2009

Related U.S. Application Data
(60) Provisional application No. 61/023,739, filed on Jan. 25, 2008.

(51) Int. Cl. B32B 37/02; B32B 37/10

(52) U.S. Cl. 156/64; 156/359; 156/295

(57) ABSTRACT

The present invention generally relates to an automated thermal processing module that is used perform a lamination process that is used to isolate the active regions of a solar cell from the external environment. One embodiment of the present invention provides an apparatus for bonding a composite solar cell structure comprising a conveyer system configured to transfer and support the composite solar cell structure, a preheat module disposed along the conveyer system, a lamination module disposed along the conveyer system, and a system controller adapted to control the preheat module and the lamination module.

### CROSS-REFERENCE TO RELATED APPLICATIONS

This application claims benefit of U.S. provisional patent application Ser. No. 61/023,739, filed Jan. 25, 2008, which is herein incorporated by reference.

This application is related to U.S. application Ser. No. 12/202,199, filed Aug. 29, 2008 (Attorney Docket No. APPM/11141) and U.S. application Ser. No. 12/201,840, filed Aug. 29, 2008 (Attorney Docket No. APPM/11141.02).

### BACKGROUND OF THE INVENTION

1. Field of the Invention

Embodiments of the present invention generally relate to the design and layout of a module used in a solar cell production line. Embodiments of the present invention also generally relate to an apparatus and processes that are useful for laminating portions of a solar cell device.

2. Description of the Related Art

Photovoltaic devices (PV) or solar cells are devices which convert sunlight into direct current (DC) electrical power. PV or solar cells typically have one or more p-i-n junctions. Each p-i-n junction comprises a p-type layer, an intrinsic type layer, and a n-type layer. When the p-i-n junction of the PV cell is exposed to sunlight (consisting of energy from photons), the sunlight is converted to electricity through the PV effect. PV solar cells may be tiled into larger modules. PV modules are created by connecting a number of PV solar cells and are then joined into panels with specific frames and connectors.

Typically, a PV solar cell includes active regions and a transparent conductive oxide (TCO) film disposed as a front electrode and/or as a back electrode. The photoelectric conversion unit includes a p-type silicon layer, a n-type silicon layer, and an intrinsic type (i-type) silicon layer sandwiched between the p-type and n-type silicon layers. Several types of silicon films including microcrystalline silicon film (μc-Si), amorphous silicon film (a-Si), polycrystalline silicon film (poly-Si) and the like may be utilized to form the p-type, n-type, and/or i-type layers of the photoelectric conversion unit. The backside contact may contain one or more conductive layers. There is a need for an improved process of forming a PV solar cell that has good interfacial contact, low contact resistance and provides a high overall electrical device performance of the PV solar cells.

With traditional energy source prices being rather high there is a need for a low cost way of producing electricity using a low cost solar cell device. Conventional solar cell manufacturing processes are highly labor intensive and have numerous interruptions that can affect the production line throughput, solar cell cost and device yield. Therefore, there is a need for a continuous non-interrupted flow of solar cell substrates through the solar cell production line to reduce cost and improve device yield.

Conventional solar cell fabrication processes contain a number of manual operations that can cause the formed solar cell device properties to vary from one device to another. Conventional processes that are used to encapsulate or isolate the active components in a formed solar cell from the external environment typically require one or more manual process steps. These manual processes are labor intensive, time consuming and costly.

In some industrial applications automated glass substrate manufacturing processes have been used to heat the glass substrate to a desired temperature to perform some annealing or thermal processing functions. However, conventional annealing or thermal hardware used to perform these steps typically is only able to control the glass temperature variations to a range of about 10° C.

To prevent environmental attack of the active regions of a solar cell a good environmental isolation process, or lamination process, that uniformly heats a formed solar cell substrate to ensure that the encapsulation material and solar cell are in a low stress state (e.g., improve lifetime of the device) and ensure that the encapsulation material, such as PVB, is able to evenly flow across the active region(s) of the solar cell is needed. The tolerance for temperature variation across formed solar cell device becomes much more critical in these types of applications and may require a variation range of less than about 4° C. To achieve a desired solar cell fabrication cost typical solar fab throughputs require >20 solar cells per hour for 2.2×2.6 meters sized solar cell modules. One complex control issue that arises at these throughputs is the variation in thermal environment seen by the first substrate versus the last substrate during a processing run, and the common changes or differences in the ambient environment (e.g., temperatures (day versus night, season to season), humidity) of typical places where solar fabs are located. Therefore, there is need for an automated lamination tool that can more precisely control the lamination process to achieve desirable thermal and mechanical results on the substrate.

### SUMMARY OF THE INVENTION

The present invention generally relates to an automated thermal processing module that is used perform a lamination process that is used to isolate the active regions of a solar cell from the external environment.

One embodiment of the present invention provides an apparatus for bonding a composite solar cell structure comprising a conveyer system configured to transfer and support the composite solar cell structure, a preheat module disposed along the conveyer system, wherein the preheat module is configured to receive the composite solar cell structure from the conveyer system and to heat the composite solar cell structure to a desired temperature, a lamination module disposed along the conveyer system, wherein the lamination module is configured to receive the composite solar cell structure from the conveyer system and to bond the composite solar cell structure by heating, and a system controller adapted to control the preheat module and the lamination module.

Another embodiment of the present invention provides a method for forming solar cells comprising preparing composite solar cell structures, wherein preparing composite solar cell structure comprises placing a bonding material over a device substrate having solar cell devices formed thereon, and placing a back glass substrate over the bonding material and the device substrate, moving the composite solar cell structures sequentially through a processing region of a preheat module while preheating the composite solar cell structures in the processing region, wherein preheating the composite solar cell structures in the preheating module comprises actively controlling temperature of the composite solar cell structures, and applying a force to the composite solar cell structures to distribute the bonding material between each back glass substrate and the corresponding device substrate, and moving the composite solar cell structures through a processing region of a lamination module while bonding each back glass substrate to the corresponding device substrate, wherein bonding each back glass substrate to the corresponding device substrate comprises actively controlling temperature of the composite solar cell structures.

Another embodiment of the present invention provides a method for processing a solar cell structure, comprising transferring the solar cell structure having one or more components to a bonding module, positioning the solar cell structure on a conveyor system, transferring the solar cell structure through a pre-heat module, applying heat to solar cell structure in the pre-heat module using at least one top heating elements disposed over a first side of the solar cell structure and at least one bottom heating elements disposed over a second side of the solar cell structure, monitoring the temperature on the first side and on the second side of the solar cell structure and adjusting the amount of heat applied to the solar cell structure in the pre-heat module by the at least one lamp disposed over a first side or the at least one lamp disposed over a second side, applying pressure solar cell structure by compression rollers disposed outside the pre-heat module, transferring the solar cell structure through a laminating module, applying heat to solar cell structure in the laminating module using at least one top heating elements disposed over a first side of the solar cell structure and at least one bottom heating elements disposed over a second side of the solar cell structure, monitoring the temperature on the first side and on the second side of the solar cell structure and adjusting the amount of heat applied to the solar cell structure in the laminating module by the at least one lamp disposed over a first side or the at least one lamp disposed over a second side, applying pressure solar cell structure by compression rollers disposed outside the laminating module, and laminating the one or more components of the solar cell structure.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. The patent or application file contains at least one drawing executed in color. Copies of this patent or patent application publication with color drawing(s) will be provided by the Office upon request and payment of the necessary fee.

FIG. 1 illustrates a process sequence according to one embodiment described herein;

FIG. 2 illustrates a plan view of a solar cell production line according to one embodiment described herein;

FIG. 3A is a side cross-sectional view of a thin film solar cell device according to one embodiment described herein;

FIG. 3B is a side cross-sectional view of a thin film solar cell device according to one embodiment described herein;

FIG. 3C is a plan view of a composite solar cell structure according to one embodiment described herein;

FIG. 3D is a side cross-sectional view along Section A-A of FIG. 3C;

FIG. 3E is a side cross-sectional view of a thin film solar cell device according to one embodiment described herein;

FIG. 4A illustrates various aspects of a lamination module assembly according to one embodiment described herein;

FIG. 4B illustrates a processing sequence according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present invention generally relates to an automated thermal processing module that is used perform a lamination process that is used to isolate the active regions of a solar cell from the external environment. The device used to perform the lamination process is generally positioned within an automated solar cell fab. The automated solar cell fab is generally an arrangement of automated processing modules and automation equipment that is used to form solar cell devices.

The automated solar fab generally comprises a substrate receiving module that is adapted to receive a substrate, one or more absorbing layer deposition cluster tools having at least one processing chamber that is adapted to deposit a silicon-containing layer on a surface of the substrate, one or more back contact deposition chambers that is adapted to deposit a back contact layer on a surface of the substrate, one or more material removal chambers that are adapted to remove material from a surface of the substrate, a solar cell encapsulation device such as a laminator, an autoclave module that is adapted to heat and expose a composite substrate structure to a pressure greater than atmospheric pressure, a junction box attaching region to attach a connection element that allows the solar cells to be connected to external components, and one or more quality assurance modules that are adapted to test and qualify the formed solar cell device. The one or more quality assurance modules will generally include a solar simulator, and a shunt bust and qualification module.

Embodiments of the invention further provide a system for processing solar cell devices, comprising substrate receiving module that is adapted to receive a substrate that has an area that is at least about 5.7 m², one or more absorbing layer deposition cluster tools having at least one processing chamber that is able to deposit a silicon-containing layer, one or more back contact deposition chambers, one or more material removal chambers that are adapted to remove material from a surface of the substrate, a junction box attachment module, and an autoclave module that is adapted to provide heat a composite structure comprising the substrate, a bonding material and a back glass substrate.

While the formation of silicon thin film solar cell devices is primarily described herein, this configuration is not intended to be limiting to the scope of the invention since the apparatus and methods disclosed herein can also be used to form, test, and analyze other types of solar cell devices, such as III-V type solar cells, thin film chalcogenide solar cells (e.g., CIGS, CdTe cells), amorphous or nanocrystalline silicon solar cells, photochemical type solar cells (e.g., dye sensitized), crystalline silicon solar cells, organic type solar cells, or other similar solar cell devices.

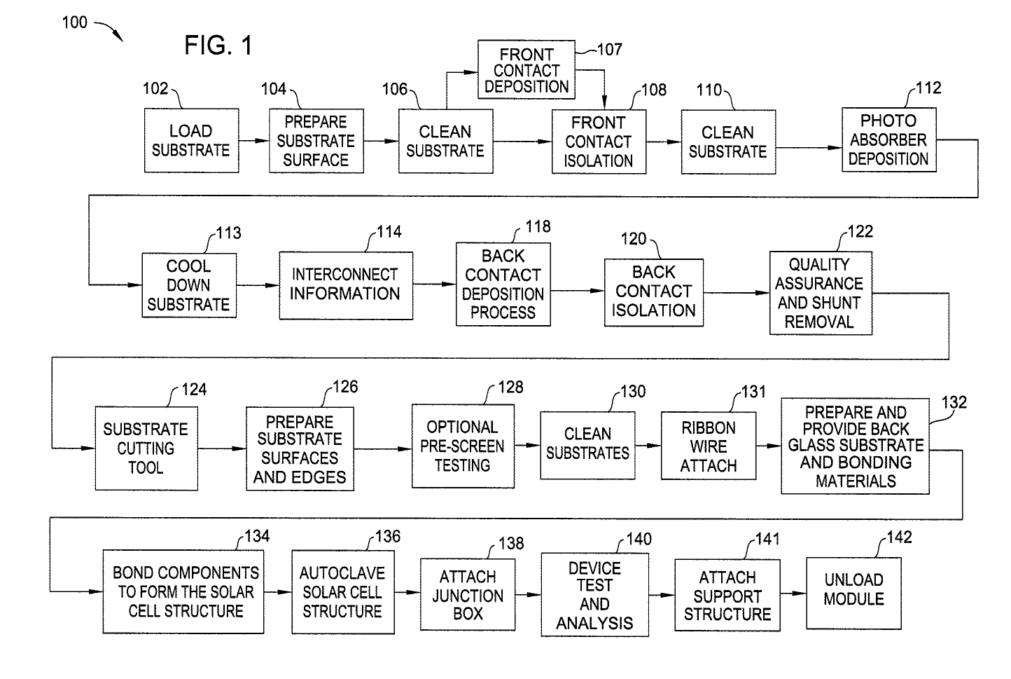

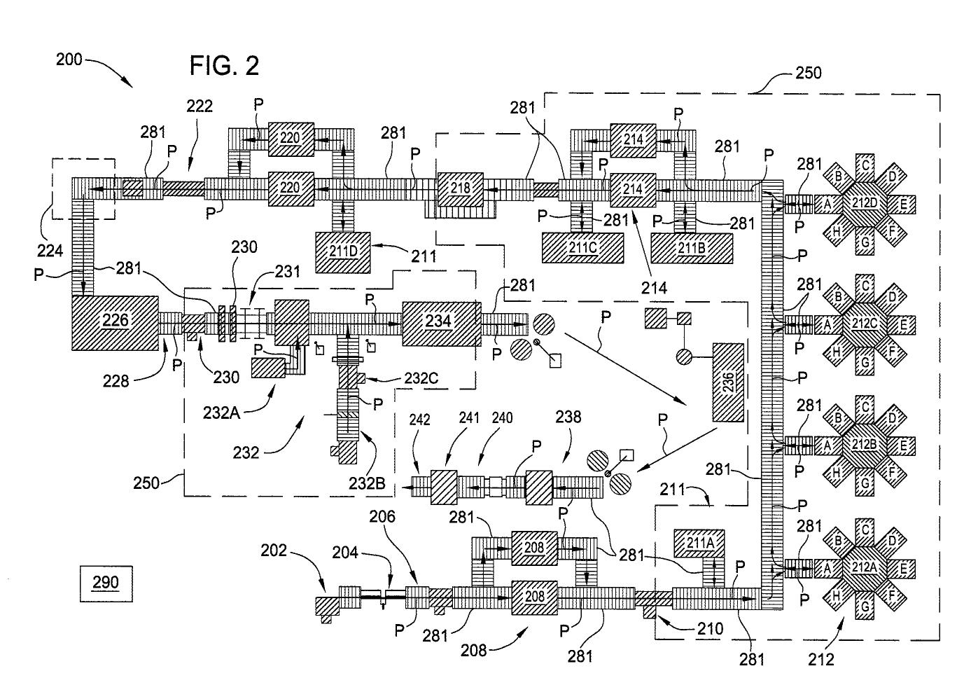

FIG. 1 illustrates one embodiment of a process sequence 100 that contains a plurality of steps (i.e., steps 102-142) that are each used to form a solar cell device using the novel solar cell production line 200 described in FIG. 2. The configuration, number of processing steps, and order of the processing steps in the process sequence 100 illustrated in FIG. 1 is not intended to be limiting to the scope of the invention described herein.

FIG. 2 is a plan view of the production line 200 which is intended to illustrate the flow of substrates through the system and other aspects of the system design. Examples and information regarding various process sequence and hardware configurations may also be found in the U.S. patent application Ser. No. 12/202,199, filed Aug. 29, 2008 (Attorney Docket No. APPM/11141), U.S. patent application Ser. No. 12/201,840, filed Aug. 29, 2008 (Attorney Docket No. APPM/11141.02), and U.S. Provisional Patent Application Ser. No. 60/967,077, which are all herein incorporated by reference in their entirety.

FIG. 1 illustrates one embodiment of a process sequence 100 that contains a plurality of steps (i.e., steps 102-142) that are each used to form a solar cell device using a novel solar cell production line 200 described herein. The configuration, number of processing steps, and order of the processing steps in the process sequence 100 is not intended to be limiting to the scope of the invention described herein. FIG. 2 is a plan view of one embodiment of the production line 200, which is intended to illustrate some of the typical processing modules and process flows through the system and other related aspects of the system design, and is thus not intended to be limiting to the scope of the invention described herein.

A system controller 290 may be used to control one or more components found in the solar cell production line 200. An example of a system controller, distributed control architecture, and other system control structure that may be useful for one or more of the embodiments described herein can be found in the U.S. Provisional Patent Application Ser. No. 12/351,087 (Attorney Docket No. 12692), filed Jan. 9, 2009, which has been incorporated by reference.

The system controller 290 facilitates the control and automation of the overall solar cell production line 200 and typically includes a central processing unit (CPU) (not shown), memory (not shown), and support circuits (or I/O) (not shown). The CPU may be one of any form of computer processors that are used in industrial settings for controlling various system functions, substrate movement, chamber processes, and support hardware (e.g., sensors, robots, motors, lamps, etc.), and monitor the processes (e.g., substrate support temperature, power supply variables, chamber process time, I/O signals, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like.

A program (or computer instructions) readable by the system controller 290 determines which tasks are performable on a substrate. In one embodiment, the program is software readable by the system controller 290 that includes code to perform tasks relating to monitoring, moving, supporting, and/or positioning of a substrate along with various process recipe tasks and various chamber process recipe steps performed in the solar cell production line 200. In one embodiment, the system controller 290 also contains a plurality of programmable logic controllers (PLC's) that are used to locally control one or more modules in the solar cell production and a material handling system controller (e.g., PLC or standard computer) that deals with the higher level strategic moving, scheduling, and running of the complete solar cell production line.

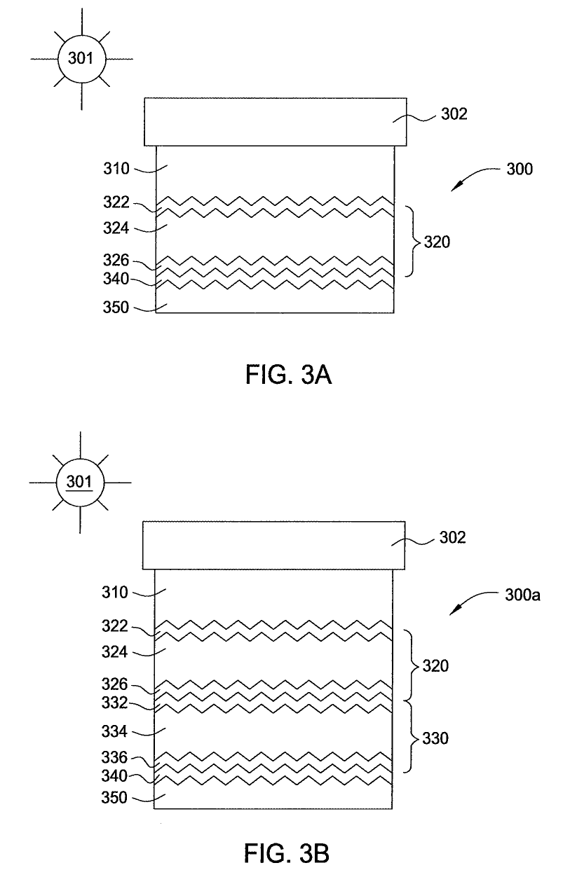

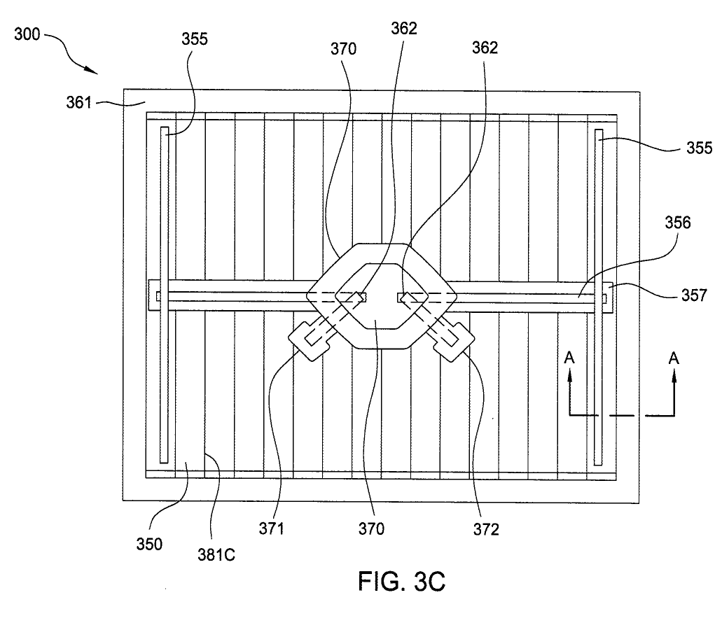

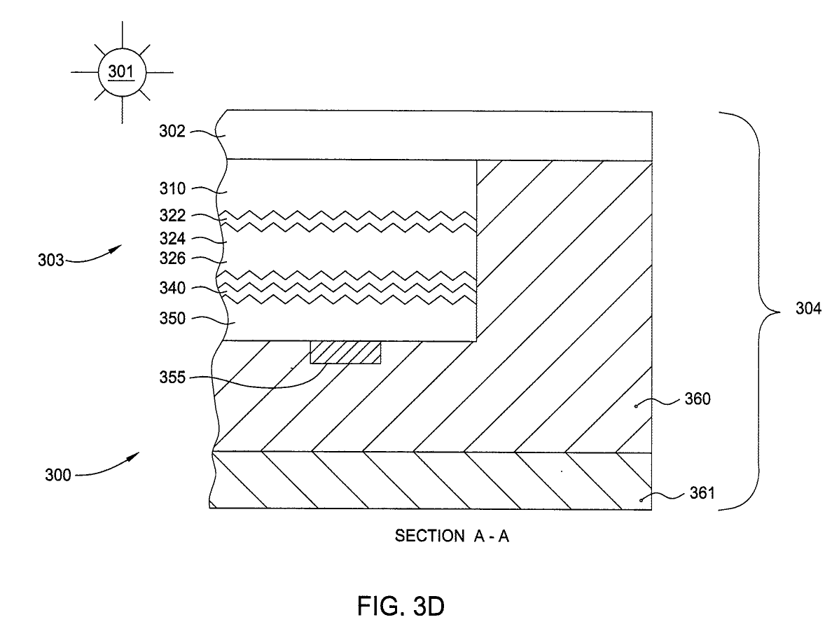

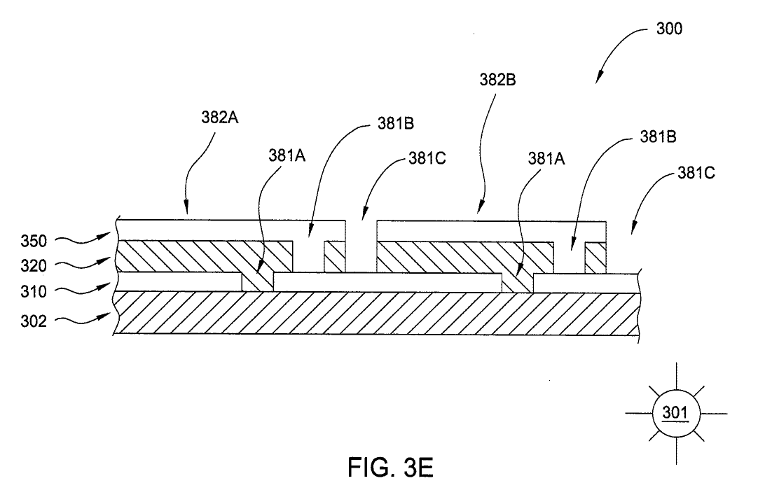

Examples of a solar cell 300 that can be formed and tested using the process sequences illustrated in FIG. 1 and the components illustrated in the solar cell production line 200 are illustrated in FIGS. 3A-3E.

FIG. 3A is a simplified schematic diagram of a single junction amorphous or micro-crystalline silicon solar cell 300 that can be formed and analyzed in the system described below.

As shown in FIG. 3A, the single junction amorphous or micro-crystalline silicon solar cell 300 is oriented toward a light source or solar radiation 301. The solar cell 300 generally comprises a substrate 302, such as a glass substrate, polymer substrate, metal substrate, or other suitable substrate, with thin films formed thereover. In one embodiment, the substrate 302 is a glass substrate that is about 2200 mm×2600 mm×3 mm in size.

The solar cell 300 further comprises a first transparent conducting oxide (TCO) layer 310 (e.g., zinc oxide (ZnO), tin oxide (SnO)) formed over the substrate 302, a first p-i-n junction 320 formed over the first TCO layer 310, a second TCO layer 340 formed over the first p-i-n junction 320, and a back contact layer 350 formed over the second TCO layer 340. To improve light absorption by enhancing light trapping, the substrate and/or one or more of the thin films formed thereover may be optionally textured by wet, plasma, ion, and/or mechanical processes. For example, in the embodiment shown in FIG. 3A, the first TCO layer 310 is textured, and the subsequent thin films deposited thereover generally follow the topography of the surface below it.

In one configuration, the first p-i-n junction 320 may comprise a p-type amorphous silicon layer 322, an intrinsic type amorphous silicon layer 324 formed over the p-type amorphous silicon layer 322, and an n-type microcrystalline silicon layer 326 formed over the intrinsic type amorphous silicon layer 324. In one example, the p-type amorphous silicon layer 322 may be formed to a thickness between about 60 Å and about 300 Å, the intrinsic type amorphous silicon layer 324 may be formed to a thickness between about 1,500 Å and about 3,500 Å, and the n-type microcrystalline silicon layer 326 may be formed to a thickness between about 100 Å and about 400 Å. The back contact layer 350 may include, but is not limited to, a material selected from the group consisting of Al, Ag, Ti, Cr, Au, Cu, Pt, alloys thereof, and combinations thereof.

FIG. 3B is a schematic diagram of an embodiment of a solar cell 300a, which is a multi-junction solar cell that is oriented toward the light or solar radiation 301. The solar cell 300a comprises a substrate 302, such as a glass substrate, polymer substrate, metal substrate, or other suitable substrate, with thin films formed thereover. The solar cell 300a may further comprise a first transparent conducting oxide (TCO) layer 310 formed over the substrate 302, a first p-i-n junction 320 formed over the first TCO layer 310, a second p-i-n junction 330 formed over the first p-i-n junction 320, a second TCO layer 340 formed over the second p-i-n junction 330, and a back contact layer 350 formed over the second TCO layer 340.

In the embodiment shown in FIG. 3B, the first TCO layer 310 is textured, and the subsequent thin films deposited thereover generally follow the topography of the surface below it. The first p-i-n junction 320 may comprise a p-type amorphous silicon layer 322, an intrinsic type amorphous silicon layer 324 formed over the p-type amorphous silicon layer 322, and an n-type microcrystalline silicon layer 326 formed over the intrinsic type amorphous silicon layer 324. In one example, the p-type amorphous silicon layer 322 may be formed to a thickness between about 60 Å and about 300 Å, the intrinsic type amorphous silicon layer 324 may be formed to a thickness between about 1,500 Å and about 3,500 Å, and the n-type microcrystalline silicon layer 326 may be formed to a thickness between about 100 Å and about 400 Å.

The second p-i-n junction 330 may comprise a p-type microcrystalline silicon layer 332, an intrinsic type microcrystalline silicon layer 334 formed over the p-type microcrystalline silicon layer 332, and an n-type amorphous silicon layer 336 formed over the intrinsic type microcrystalline silicon layer 334. In one example, the p-type microcrystalline silicon layer 332 may be formed to a thickness between about 100 Å and about 400 Å, the intrinsic type microcrystalline silicon layer 334 may be formed to a thickness between about 10,000 Å and about 30,000 Å, and the n-type amorphous silicon layer 336 may be formed to a thickness between about 100 Å and about 500 Å. The back contact layer 350 may include, but is not limited to a material selected from the group consisting of Al, Ag, Ti, Cr, Au, Cu, Pt, alloys thereof, and combinations thereof.

FIG. 3C is a plan view that schematically illustrates an example of the rear surface of a formed solar cell 300 or the solar cell 300a that has been produced and tested in the production line 200. FIG. 3D is a side cross-sectional view of a portion of the solar cell 300 illustrated in FIG. 3C (see section A-A). While FIG. 3D illustrates the cross-section of a single junction cell similar to the configuration described in FIG. 3A, this is not intended to be limiting as to the scope of the invention described herein.

As shown in FIGS. 3C and 3D, the solar cell 300 may contain a substrate 302, the solar cell device elements (e.g., reference numerals 310-350), one or more internal electrical connections (e.g., side buss 355, cross-buss 356), a layer of bonding material 360, a back glass substrate 361, and a junction box 370. The junction box 370 may generally contain two junction box terminals 371, 372 that are electrically connected to portions of the solar cell 300 through the side buss 355 and the cross-buss 356, which are in electrical communication with the back contact layer 350 and active regions of the solar cell 300. To avoid confusion relating to the actions specifically performed on the substrates 302 in the discussion below, a substrate 302 having one or more of the deposited layers (e.g., reference numerals 310-350) and/or one or more internal electrical connections (e.g., side buss 355, cross-buss 356) disposed thereon is generally referred to as a device substrate 303. Similarly, a device substrate 303 that has been bonded to a back glass substrate 361 using a bonding material 360 is referred to as a composite solar cell structure 304.

FIG. 3E is a schematic cross-section of the solar cell 300 illustrating various scribed regions used to form the individual cells 382A-382B within the solar cell 300. As illustrated in FIG. 3E, the solar cell 300 includes a transparent substrate 302, a first TCO layer 310, a first p-i-n junction 320, and a back contact layer 350.

Three laser scribing steps may be performed to produce trenches 381A, 381B, and 381C, which are generally required to form a high efficiency solar cell device. Although formed together on the substrate 302, the individual cells 382A and 382B are isolated from each other by the insulating trench 381C formed in the back contact layer 350 and the first p-i-n junction 320. In addition, the trench 381B is formed in the first p-i-n junction 320 so that the back contact layer 350 is in electrical contact with the first TCO layer 310.

In one embodiment, the insulating trench 381A is formed by the laser scribe removal of a portion of the first TCO layer 310 prior to the deposition of the first p-i-n junction 320 and the back contact layer 350. Similarly, in one embodiment, the trench 381 B is formed in the first p-i-n junction 320 by the laser scribe removal of a portion of the first p-i-n junction 320 prior to the deposition of the back contact layer 350. While a single junction type solar cell is illustrated in FIG. 3E this configuration is not intended to be limiting to the scope of the invention described herein.

### General Solar Cell Formation Process Sequence

Referring to FIGS. 1 and 2, the process sequence 100 generally starts at step 102 in which a substrate 302 is loaded into the loading module 202 found in the solar cell production line 200. In one embodiment, the substrates 302 are received in a “raw” state where the edges, overall size, and/or cleanliness of the substrates 302 are not well controlled. Receiving “raw” substrates 302 reduces the cost to prepare and store substrates 302 prior to forming a solar device and thus reduces the solar cell device cost, facilities costs, and production costs of the finally formed solar cell device. However, typically, it is advantageous to receive “raw” substrates 302 that have a transparent conducting oxide (TCO) layer (e.g., first TCO layer 310) already deposited on a surface of the substrate 302 before it is received into the system in step 102. If a conductive layer, such as TCO layer, is not deposited on the surface of the “raw” substrates then a front contact deposition step (step 107), which is discussed below, needs to be performed on a surface of the substrate 302.

In one embodiment, the substrates 302 or 303 are loaded into the solar cell production line 200 in a sequential fashion, and thus do not use a cassette or batch style substrate loading system. A cassette style and/or batch loading type system that requires the substrates to be un-loaded from the cassette, processed, and then returned to the cassette before moving to the next step in the process sequence can be time consuming and decrease the solar cell production line throughput. The use of batch processing does not facilitate certain embodiments of the present invention, such as fabricating multiple solar cell devices from a single substrate. Additionally, the use of a batch style process sequence generally prevents the use of an asynchronous flow of substrates through the production line, which may provide improved substrate throughput during steady state processing and when one or more modules are brought down for maintenance or due to a fault condition. Generally, batch or cassette based schemes are not able to achieve the throughput of the production line described herein, when one or more processing modules are brought down for maintenance, or even during normal operation, since the queuing and loading of substrates can require a significant amount of overhead time.

In the next step, step 104, the surfaces of the substrate 302 are prepared to prevent yield issues later on in the process. In one embodiment of step 104, the substrate is inserted into a front end substrate seaming module 204 that is used to prepare the edges of the substrate 302 or 303 to reduce the likelihood of damage, such as chipping or particle generation from occurring during the subsequent processes. Damage to the substrate 302 or 303 can affect device yield and the cost to produce a usable solar cell device. In one embodiment, the front end substrate seaming module 204 is used to round or bevel the edges of the substrate 302 or 303. In one embodiment, a diamond impregnated belt or disc is used to grind the material from the edges of the substrate 302 or 303. In another embodiment, a grinding wheel, grit blasting, or laser ablation technique is used to remove the material from the edges of the substrate 302 or 303.

Next the substrate 302 or 303 is transported to the cleaning module 206, in which step 106, or a substrate cleaning step, is performed on the substrate 302 or 303 to remove any contaminants found on the surface of thereof. Common contaminants may include materials deposited on the substrate 302 or 303 during the substrate forming process (e.g., glass manufacturing process) and/or during shipping or storing of the substrates 302 or 303. Typically, the cleaning module 206 uses wet chemical scrubbing and rinsing steps to remove any undesirable contaminants.

In one example, the process of cleaning the substrate 302 or 303 may occur as follows. First, the substrate 302 or 303 enters a contaminant removal section of the cleaning module 206 from either a transfer table or an automation device 281. In general, the system controller 290 establishes the timing for each substrate 302 or 303 that enters the cleaning module 206. The contaminant removal section may utilize dry cylindrical brushes in conjunction with a vacuum system to dislodge and extract contaminants from the surface of the substrate 302. Next, a conveyor within the cleaning module 206 transfers the substrate 302 or 303 to a pre-rinse section, where spray tubes dispense hot DI water at a temperature, for example, of 50° C. from a DI water heater onto a surface of the substrate 302 or 303. Commonly, since the device substrate 303 has a TCO layer disposed thereon, and since TCO layers are generally electron absorbing materials, DI water is used to avoid any traces of possible contamination and ionizing of the TCO layer. Next, the rinsed substrate 302, 303 enters a wash section. In the wash section, the substrate 302 or 303 is wet-cleaned with a brush (e.g., perlon) and hot water. In some cases a detergent (e.g., Alconox™, Citrajet™, Detojet™, Transene™, and Basic H™), surfactant, pH adjusting agent, and other cleaning chemistries are used to clean and remove unwanted contaminants and particles from the substrate surface. A water re-circulation system recycles the hot water flow. Next, in a final rinse section of the cleaning module 206, the substrate 302 or 303 is rinsed with water at ambient temperature to remove any traces of contaminants. Finally, in a drying section, an air blower is used to dry the substrate 302 or 303 with hot air. In one configuration a deionization bar is used to remove the electrical charge from the substrate 302 or 303 at the completion of the drying process.

In the next step, or step 108, separate cells are electrically isolated from one another via scribing processes. Contamination particles on the TCO surface and/or on the bare glass surface can interfere with the scribing procedure. In laser scribing, for example, if the laser beam runs across a particle, it may be unable to scribe a continuous line, resulting in a short circuit between cells. In addition, any particulate debris present in the scribed pattern and/or on the TCO of the cells after scribing can cause shunting and non-uniformities between layers. Therefore, a well-defined and well-maintained process is generally needed to ensure that contamination is removed throughout the production process. In one embodiment, the cleaning module 206 is available from the Energy and Environment Solutions division of Applied Materials in Santa Clara, Calif.

Referring to FIGS. 1 and 2, in one embodiment, prior to performing step 108 the substrates 302 are transported to a front end processing module (not illustrated in FIG. 2) in which a front contact formation process, or step 107, is performed on the substrate 302. In one embodiment, the front end processing module is similar to the processing module 218 discussed below. In step 107, the one or more substrate front contact formation steps may include one or more preparation, etching, and/or material deposition steps to form the front contact regions on a bare solar cell substrate 302. In one embodiment, step 107 comprises one or more PVD steps that are used to form the front contact region on a surface of the substrate 302. In one embodiment, the front contact region contains a transparent conducting oxide (TCO) layer that may contain metal element selected from a group consisting of zinc (Zn), aluminum (Al), indium (In), and tin (Sn). In one example, a zinc oxide (ZnO) is used to form at least a portion of the front contact layer. In one embodiment, the front end processing module is an ATON™ PVD 5.7 tool available from Applied Materials in Santa Clara, Calif. in which one or more processing steps are performed to deposit the front contact region. In another embodiment, one or more CVD steps are used to form the front contact region on a surface of the substrate 302.

Next the device substrate 303 is transported to the scribe module 208 in which step 108, or a front contact isolation step, is performed on the device substrate 303 to electrically isolate different regions of the device substrate 303 surface from each other. In step 108, material is removed from the device substrate 303 surface by use of a material removal step, such as a laser ablation process. The success criteria for step 108 are to achieve good cell-to-cell and cell-to-edge isolation while minimizing the scribe area.

In one embodiment, a Nd:vanadate (Nd:YVO₄) laser source is used ablate material from the device substrate 303 surface to form lines that electrically isolate one region of the device substrate 303 from the next. In one embodiment, the laser scribe process performed during step 108 uses a 1064 nm wavelength pulsed laser to pattern the material disposed on the substrate 302 to isolate each of the individual cells (e.g., reference cells 382A and 382B) that make up the solar cell 300. In one embodiment, a 5.7 m² substrate laser scribe module available from Applied Materials, Inc. of Santa Clara, Calif. is used to provide simple reliable optics and substrate motion for accurate electrical isolation of regions of the device substrate 303 surface. In another embodiment, a water jet cutting tool or diamond scribe is used to isolate the various regions on the surface of the device substrate 303.

It may be desirable to assure that the temperature of the device substrates 303 entering the scribe module 208 are at a temperature in a range between about 20° C. and about 26° C. by use of an active temperature control hardware assembly that may contain a resistive heater and/or chiller components (e.g., heat exchanger, thermoelectric device). In one embodiment, it is desirable to control the device substrate 303 temperature to about 25±0.5° C.

Next the device substrate 303 is transported to the cleaning module 210 in which step 110, or a pre-deposition substrate cleaning step, is performed on the device substrate 303 to remove any contaminants found on the surface of the device substrate 303 after performing the cell isolation step (step 108). Typically, the cleaning module 210 uses wet chemical scrubbing and rinsing steps to remove any undesirable contaminants found on the device substrate 303 surface after performing the cell isolation step. In one embodiment, a cleaning process similar to the processes described in step 106 above is performed on the device substrate 303 to remove any contaminants on the surface(s) of the device substrate 303.

A testing and analysis step, step 111, may be performed to test and analyze various regions, or test structures, formed on a portion of a partially formed solar cell device.

Next, the device substrate 303 is transported to the processing module 212 in which step 112, which comprises one or more photoabsorber deposition steps, is performed on the device substrate 303. In step 112, the one or more photoabsorber deposition steps may include one or more preparation, etching, and/or material deposition steps that are used to form the various regions of the solar cell device. Step 112 generally comprises a series of sub-processing steps that are used to form one or more p-i-n junctions. In one embodiment, the one or more p-i-n junctions comprise amorphous silicon and/or microcrystalline silicon materials. In general, the one or more processing steps are performed in one or more cluster tools (e.g., cluster tools 212A-212D) found in the processing module 212 to form one or more layers in the solar cell device formed on the device substrate 303. In one embodiment, the device substrate 303 is transferred to an accumulator 211A prior to being transferred to one or more of the cluster tools 212A-212D. In one embodiment, in cases where the solar cell device is formed to include multiple junctions, such as the tandem junction solar cell 300 illustrated in FIG. 3B, the cluster tool 212A in the processing module 212 is adapted to form the first p-i-n junction 320 and cluster tools 212B-212D are configured to form the second p-i-n junction 330.

In one embodiment of the process sequence 100, a cool down step, or step 113, is performed after step 112 has been performed. The cool down step is generally used to stabilize the temperature of the device substrate 303 to assure that the processing conditions seen by each device substrate 303 in the subsequent processing steps are repeatable. Generally, the temperature of the device substrate 303 exiting the processing module 212 could vary by many degrees Celsius and exceed a temperature of 50° C., which can cause variability in the subsequent processing steps and solar cell performance.

In one embodiment, the cool down step 113 is performed in one or more of the substrate supporting positions found in one or more accumulators 211. In one configuration of the production line, as shown in FIG. 2, the processed device substrates 303 may be positioned in one of the accumulators 211B for a desired period of time to control the temperature of the device substrate 303. In one embodiment, the system controller 290 is used to control the positioning, timing, and movement of the device substrates 303 through the accumulator(s) 211 to control the temperature of the device substrates 303 before proceeding down stream through the production line.

Next, the device substrate 303 is transported to the scribe module 214 in which step 114, or the interconnect formation step, is performed on the device substrate 303 to electrically isolate various regions of the device substrate 303 surface from each other. In step 114, material is removed from the device substrate 303 surface by use of a material removal step, such as a laser ablation process. In one embodiment, an Nd:vanadate (Nd:YVO₄) laser source is used ablate material from the substrate surface to form lines that electrically isolate one solar cell from the next. In one embodiment, a 5.7 m² substrate laser scribe module available from Applied Materials, Inc. is used to perform the accurate scribing process. In one embodiment, the laser scribe process performed during step 108 uses a 532 nm wavelength pulsed laser to pattern the material disposed on the device substrate 303 to isolate the individual cells that make up the solar cell 300. As shown in FIG. 3E, in one embodiment, the trench 381B is formed in the first p-i-n junction 320 layers by use of a laser scribing process. In another embodiment, a water jet cutting tool or diamond scribe is used to isolate the various regions on the surface of the solar cell.

It may be desirable to assure that the temperature of the device substrates 303 entering the scribe module 214 are at a temperature in a range between about 20° C. and about 26° C. by use of an active temperature control hardware assembly that may contain a resistive heater and/or chiller components (e.g., heat exchanger, thermoelectric device). In one embodiment, it is desirable to control the substrate temperature to about 25±0.5° C.

In one embodiment, the solar cell production line 200 has at least one accumulator 211 positioned after the scribe module(s) 214. During production accumulators 211C may be used to provide a ready supply of substrates to the processing module 218, and/or provide a collection area where substrates coming from the processing module 212 can be stored if the processing module 218 goes down or can not keep up with the throughput of the scribe module(s) 214. In one embodiment it is generally desirable to monitor and/or actively control the temperature of the substrates exiting the accumulators 211C to assure that the results of the back contact formation step 120 are repeatable. In one aspect, it is desirable to assure that the temperature of the substrates exiting the accumulators 211C or arriving at the processing module 218 are at a temperature in a range between about 20° C. and about 26° C. In one embodiment, it is desirable to control the substrate temperature to about 25±0.5° C. In one embodiment, it is desirable to position one or more accumulators 211C that are able to retain at least about 80 substrates.

Next, the device substrate 303 is transported to the processing module 218 in which one or more substrate back contact formation steps, or step 118, are performed on the device substrate 303. In step 118, the one or more substrate back contact formation steps may include one or more preparation, etching, and/or material deposition steps that are used to form the back contact regions of the solar cell device. In one embodiment, step 118 generally comprises one or more PVD steps that are used to form the back contact layer 350 on the surface of the device substrate 303. In one embodiment, the one or more PVD steps are used to form a back contact region that contains a metal layer selected from a group consisting of zinc (Zn), tin (Sn), aluminum (Al), copper (Cu), silver (Ag), nickel (Ni), and vanadium (V). In one example, a zinc oxide (ZnO) or nickel vanadium alloy (NiV) is used to form at least a portion of the back contact layer 305. In one embodiment, the one or more processing steps are performed using an ATON™ PVD 5.7 tool available from Applied Materials in Santa Clara, Calif. In another embodiment, one or more CVD steps are used to form the back contact layer 350 on the surface of the device substrate 303.

In one embodiment, the solar cell production line 200 has at least one accumulator 211 positioned after the processing module 218. During production, the accumulators 211 D may be used to provide a ready supply of substrates to the scribe modules 220, and/or provide a collection area where substrates coming from the processing module 218 can be stored if the scribe modules 220 go down or can not keep up with the throughput of the processing module 218. In one embodiment it is generally desirable to monitor and/or actively control the temperature of the substrates exiting the accumulators 211D to assure that the results of the back contact formation step 120 are repeatable. In one aspect, it is desirable to assure that the temperature of the substrates exiting the accumulators 211D or arriving at the scribe module 220 are at a temperature in a range between about 20° C. and about 26° C. In one embodiment, it is desirable to control the substrate temperature to about 25±0.5° C. In one embodiment, it is desirable to position one or more accumulators 211C that are able to retain at least about 80 substrates.

Next, the device substrate 303 is transported to the scribe module 220 in which step 120, or a back contact isolation step, is performed on the device substrate 303 to electrically isolate the plurality of solar cells contained on the substrate surface from each other. In step 120, material is removed from the substrate surface by use of a material removal step, such as a laser ablation process. In one embodiment, a Nd:vanadate (Nd:YVO₄) laser source is used ablate material from the device substrate 303 surface to form lines that electrically isolate one solar cell from the next. In one embodiment, a 5.7 m² substrate laser scribe module, available from Applied Materials, Inc., is used to accurately scribe the desired regions of the device substrate 303. In one embodiment, the laser scribe process performed during step 120 uses a 532 nm wavelength pulsed laser to pattern the material disposed on the device substrate 303 to isolate the individual cells that make up the solar cell 300. As shown in FIG. 3E, in one embodiment, the trench 381C is formed in the first p-i-n junction 320 and back contact layer 350 by use of a laser scribing process.

It may be desirable to assure that the temperature of the device substrates 303 entering the scribe module 220 are at a temperature in a range between about 20° C. and about 26° C. by use of an active temperature control hardware assembly that may contain a resistive heater and/or chiller components (e.g., heat exchanger, thermoelectric device). In one embodiment, it is desirable to control the substrate temperature to about 25±0.5° C.

A testing and analysis step, step 123, may be performed to test and analyze various regions, or test structures, formed on a portion of a partially formed solar cell device after step 120.

Next, the device substrate 303 is transported to the quality assurance module 222 in which step 122, or quality assurance and/or shunt removal steps, are performed on the device substrate 303 to assure that the devices formed on the substrate surface meet a desired quality standard and in some cases correct defects in the formed device. In step 122, a probing device is used to measure the quality and material properties of the formed solar cell device by use of one or more substrate contacting probes.

In one embodiment, the quality assurance module 222 projects a low level of light at the p-i-n junction(s) of the solar cell and uses the one more probes to measure the output of the cell to determine the electrical characteristics of the formed solar cell device(s). If the module detects a defect in the formed device, it can take corrective actions to fix the defects in the formed solar cells on the device substrate 303. In one embodiment, if a short or other similar defect is found, it may be desirable to create a reverse bias between regions on the substrate surface to control and or correct one or more of the defectively formed regions of the solar cell device. During the correction process the reverse bias generally delivers a voltage high enough to cause the defects in the solar cells to be corrected. In one example, if a short is found between supposedly isolated regions of the device substrate 303 the magnitude of the reverse bias may be raised to a level that causes the conductive elements in areas between the isolated regions to change phase, decompose, or become altered in some way to eliminate or reduce the magnitude of the electrical short.

In one embodiment of the process sequence 100, the quality assurance module 222 and factory automation system are used together to resolve quality issues found in a formed device substrate 303 during the quality assurance testing. In one case, a device substrate 303 may be sent back upstream in the processing sequence to allow one or more of the fabrication steps to be re-performed on the device substrate 303 (e.g., back contact isolation step (step 120)) to correct one or more quality issues with the processed device substrate 303.

Next, the device substrate 303 is optionally transported to the substrate sectioning module 224 in which a substrate sectioning step 124 is used to cut the device substrate 303 into a plurality of smaller device substrates 303 to form a plurality of smaller solar cell devices. In one embodiment of step 124, the device substrate 303 is inserted into substrate sectioning module 224 that uses a CNC glass cutting tool to accurately cut and section the device substrate 303 to form solar cell devices that are a desired size. In one embodiment, the device substrate 303 is inserted into the cutting module 224 that uses a glass scribing tool to accurately score the surface of the device substrate 303. The device substrate 303 is then broken along the scored lines to produce the desired size and number of sections needed for the completion of the solar cell devices.

In one embodiment, steps 102-122 can be configured to use equipment that is adapted to perform process steps on large device substrates 303, such as 2200 mm×2600 mm×3 mm glass device substrates 303, and steps 124 onward can be adapted to fabricate various smaller sized solar cell devices with no additional equipment required. In another embodiment, step 124 is positioned in the process sequence 100 prior to step 122 so that the initially large device substrate 303 can be sectioned to form multiple individual solar cells that are then tested and characterized one at a time or as a group (i.e., two or more at a time). In this case, steps 102-121 are configured to use equipment that is adapted to perform process steps on large device substrates 303, such as 2200 mm×2600 mm×3 mm glass substrates, and steps 124 and 122 onward are adapted to fabricate various smaller sized modules with no additional equipment required.

Referring back to FIGS. 1 and 2, the device substrate 303 is next transported to the seamer/edge deletion module 226 in which a substrate surface and edge preparation step 126 is used to prepare various surfaces of the device substrate 303 to prevent yield issues later on in the process. In one embodiment of step 126, the device substrate 303 is inserted into seamer/edge deletion module 226 to prepare the edges of the device substrate 303 to shape and prepare the edges of the device substrate 303. Damage to the device substrate 303 edge can affect the device yield and the cost to produce a usable solar cell device. In another embodiment, the seamer/edge deletion module 226 is used to remove deposited material from the edge of the device substrate 303 (e.g., 10 mm) to provide a region that can be used to form a reliable seal between the device substrate 303 and the backside glass (i.e., steps 134-136 discussed below). Material removal from the edge of the device substrate 303 may also be useful to prevent electrical shorts in the final formed solar cell.

In one embodiment, a diamond impregnated belt is used to grind the deposited material from the edge regions of the device substrate 303. In another embodiment, a grinding wheel is used to grind the deposited material from the edge regions of the device substrate 303. In another embodiment, dual grinding wheels are used to remove the deposited material from the edge of the device substrate 303. In yet another embodiment, grit blasting or laser ablation techniques are used to remove the deposited material from the edge of the device substrate 303. In one aspect, the seamer/edge deletion module 226 is used to round or bevel the edges of the device substrate 303 by use of shaped grinding wheels, angled and aligned belt sanders, and/or abrasive wheels.

Next the device substrate 303 is transported to the pre-screen module 228 in which optional pre-screen steps 128 are performed on the device substrate 303 to assure that the devices formed on the substrate surface meet a desired quality standard. In step 128, a light emitting source and probing device are used to measure the output of the formed solar cell device by use of one or more substrate contacting probes. If the module 228 detects a defect in the formed device it can take corrective actions or the solar cell can be scrapped.

Next the device substrate 303 is transported to the cleaning module 230 in which step 130, or a pre-lamination substrate cleaning step, is performed on the device substrate 303 to remove any contaminants found on the surface of the substrates 303 after performing steps 122-128. Typically, the cleaning module 230 uses wet chemical scrubbing and rinsing steps to remove any undesirable contaminants found on the substrate surface after performing the cell isolation step. In one embodiment, a cleaning process similar to the processes described in step 106 is performed on the substrate 303 to remove any contaminants on the surface(s) of the substrate 303.

Next the substrate 303 is transported to a bonding wire attach module 231 in which step 131, or a bonding wire attach step, is performed on the substrate 303. Step 131 is used to attach the various wires/leads required to connect the various external electrical components to the formed solar cell device. Typically, the bonding wire attach module 231 is an automated wire bonding tool that reliably and quickly forms the numerous interconnects that are often required to form the large solar cells formed in the production line 200.

In one embodiment, the bonding wire attach module 231 is used to form the side-buss 355 (FIG. 3C) and cross-buss 356 on the formed back contact region (step 118). In this configuration the side-buss 355 may be a conductive material that can be affixed, bonded, and/or fused to the back contact layer 350 found in the back contact region to form a good electrical contact. In one embodiment, the side-buss 355 and cross-buss 356 each comprise a metal strip, such as copper tape, a nickel coated silver ribbon, a silver coated nickel ribbon, a tin coated copper ribbon, a nickel coated copper ribbon, or other conductive material that can carry the current delivered by the solar cell and be reliably bonded to the metal layer in the back contact region. In one embodiment, the metal strip is between about 2 mm and about 10 mm wide and between about 1 mm and about 3 mm thick.

The cross-buss 356, which is electrically connected to the side-buss 355 at the junctions, can be electrically isolated from the back contact layer(s) of the solar cell by use of an insulating material 357, such as an insulating tape. The ends of each of the cross-busses 356 generally have one or more leads 362 that are used to connect the side-buss 355 and the cross-buss 356 to the electrical connections found in a junction box 370, which is used to connect the formed solar cell to the other external electrical components.

In the next step, step 132, a bonding material 360 (FIG. 3D) and “back glass” substrate 361 are prepared for delivery into the solar cell formation process (i.e., process sequence 100). The preparation process is performed in the glass lay-up module 232, which comprises a material preparation module 232A, a glass loading module 232B, and a glass cleaning module 232C. The back glass substrate 361 is bonded onto the device substrate 303 formed in steps 102-130 above by use of a laminating process (step 134 discussed below). In one embodiment of step 132, a polymeric material is prepared to be placed between the back glass substrate 361 and the deposited layers on the device substrate 303 to form a hermetic seal to prevent the environment from attacking the solar cell during its life.

Referring to FIG. 2, step 132 comprises a series of sub-steps in which a bonding material 360 is prepared in the material preparation module 232A, the bonding material 360 is then placed over the device substrate 303, the back glass substrate 361 is loaded into the loading module 232B and washed by the cleaning module 232C, and the back glass substrate 361 is then placed over the bonding material 360 and the device substrate 303.

In one embodiment, the material preparation module 232A is adapted to receive the bonding material 360 in a sheet form and perform one or more cutting operations to provide a bonding material, such as Polyvinyl Butyral (PVB) or Ethylene Vinyl Acetate (EVA) sized to form a reliable seal between the backside glass and the solar cells formed on the device substrate 303. In general, when using bonding materials 360 that are polymeric, it is desirable to control the temperature (e.g., 16-18° C.) and relative humidity (e.g., RH 20-22%) of the solar cell production line 200 where the bonding material 360 is stored and integrated into the solar cell device to assure that the attributes of the bond formed in the bonding module 234 are repeatable and the dimensions of the polymeric material are stable. It is generally desirable to store the bonding material prior to use in temperature and humidity controlled area (e.g., T=6-8° C.; RH=20-22%).

The tolerance stack up of the various components in the bonded device (Step 134) can be an issue when forming large solar cells. Therefore, accurate control of the bonding material properties and tolerances of the cutting process assure that a reliable hermetic seal is formed. In one embodiment, PVB may be used to advantage due to its UV stability, moisture resistance, thermal cycling, good US fire rating, compliance with Intl Building Code, low cost, and reworkable thermoplastic properties.

In one part of step 132, the bonding material 360 is transported and positioned over the back contact layer 350, the side-buss 355 (FIG. 3C), and the cross-buss 356 (FIG. 3C) elements of the device substrate 303 using an automated robotic device. The device substrate 303 and bonding material 360 are then positioned to receive a back glass substrate 361, which can be placed thereon by use of the same automated robotic device used to position the bonding material 360, or a second automated robotic device.

In one embodiment, prior to positioning the back glass substrate 361 over the bonding material 360, one or more preparation steps are performed to the back glass substrate 361 to assure that subsequent sealing processes and final solar product are desirably formed. In one case, the back glass substrate 361 is received in a “raw” state where the edges, overall size, and/or cleanliness of the substrate 361 are not well controlled. Receiving “raw” substrates reduces the cost to prepare and store substrates prior to forming a solar device and thus reduces the solar cell device cost, facilities costs, and production costs of the finally formed solar cell device. In one embodiment of step 132, the back glass substrate 361 surfaces and edges are prepared in a seaming module (e.g., a front end substrate seaming module 204) prior to performing the back glass substrate cleaning step. In the next sub-step of step 132, the back glass substrate 361 is transported to the cleaning module 232C in which a substrate cleaning step is performed on the substrate 361 to remove any contaminants found on the surface of the substrate 361. Common contaminants may include materials deposited on the substrate 361 during the substrate forming process (e.g., glass manufacturing process) and/or during shipping of the substrates 361. Typically, the cleaning module 232C uses wet chemical scrubbing and rinsing steps to remove any undesirable contaminants as discussed above. The prepared back glass substrate 361 is then positioned over the bonding material and the device substrate 303 by use of an automated robotic device.

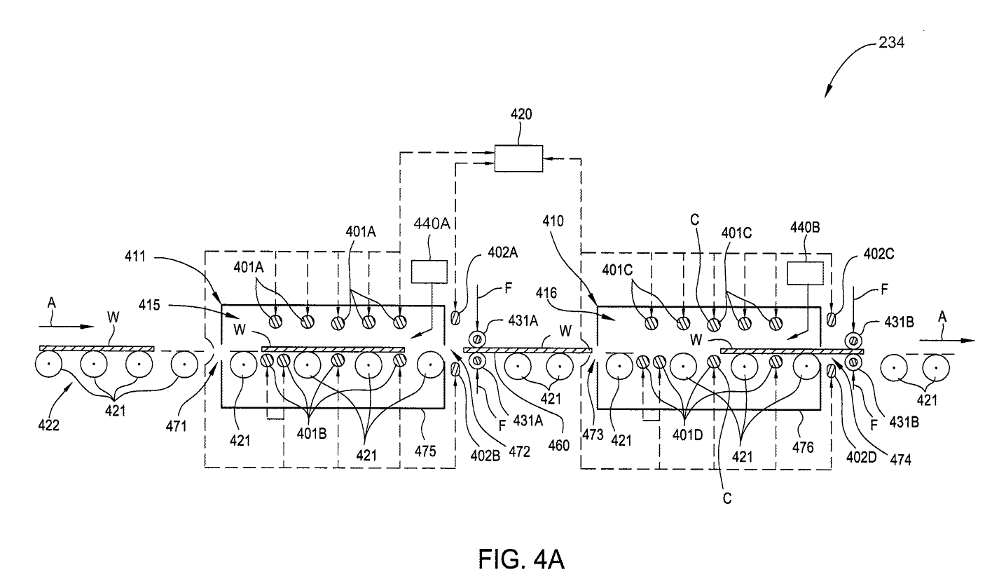

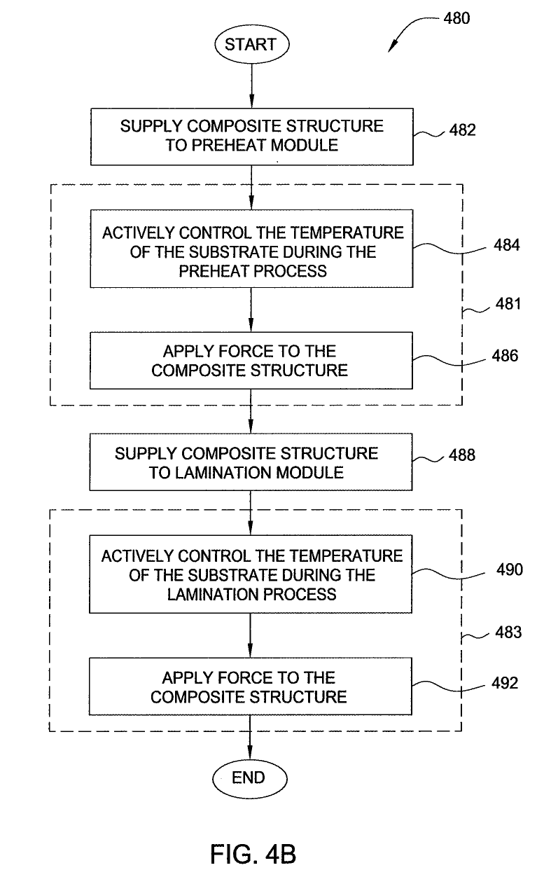

Next the device substrate 303, the back glass substrate 361, and the bonding material 360 are transported to the bonding module 234 in which step 134, or lamination steps are performed to bond the backside glass substrate 361 to the device substrate formed in steps 102-130 discussed above. In step 134, a bonding material 360, such as Polyvinyl Butyral (PVB) or Ethylene Vinyl Acetate (EVA), is sandwiched between the backside glass substrate 361 and the device substrate 303. Heat and pressure are applied to the structure to form a bonded and sealed device using various heating elements and other devices found in the bonding module 234. The device substrate 303, the back glass substrate 361, and the bonding material 360 thus form a composite solar cell structure 304 (FIG. 3D) that at least partially encapsulates the active regions of the solar cell device. In one embodiment, at least one hole formed in the back glass substrate 361 remains at least partially uncovered by the bonding material 360 to allow portions of the cross-buss 356 or the side buss 355 to remain exposed so that electrical connections can be made to these regions of the solar cell structure 304 in future steps (i.e., step 138). The process(es) and apparatus used to perform step 134 are further described below in conjunction with a processing sequence 480 and FIGS. 4A-4B.

Next the composite solar cell structure 304 is transported to the autoclave module 236 in which step 136, or autoclave steps are performed on the composite solar cell structure 304 to remove trapped gasses in the bonded structure and assure that a good bond is formed during step 134. In step 134, a bonded solar cell structure 304 is inserted in the processing region of the autoclave module where heat and high pressure gases are delivered to reduce the amount of trapped gas and improve the properties of the bond between the device substrate 303, back glass substrate, and bonding material 360. The processes performed in the autoclave are also useful to assure that the stress in the glass and bonding layer (e.g., PVB layer) are more controlled to prevent future failures of the hermetic seal or failure of the glass due to the stress induced during the bonding/lamination process. In one embodiment, it may be desirable to heat the device substrate 303, back glass substrate 361, and bonding material 360 to a temperature that causes stress relaxation in one or more of the components in the formed solar cell structure 304.

Next the solar cell structure 304 is transported to the junction box attachment module 238 in which junction box attachment steps 138 are performed on the formed solar cell structure 304. The junction box attachment module 238, used during step 138, is used to install a junction box 370 (FIG. 3C) on a partially formed solar cell. The installed junction box 370 acts as an interface between the external electrical components that will connect to the formed solar cell, such as other solar cells or a power grid, and the internal electrical connections points, such as the leads, formed during step 131. In one embodiment, the junction box 370 contains one or more junction box terminals 371, 372 so that the formed solar cell can be easily and systematically connected to other external devices to deliver the generated electrical power.

Next the solar cell structure 304 is transported to the device testing module 240 in which device screening and analysis steps 140 are performed on the solar cell structure 304 to assure that the devices formed on the solar cell structure 304 surface meet desired quality standards. In one embodiment, the device testing module 240 is a solar simulator module that is used to qualify and test the output of the one or more formed solar cells. In step 140, a light emitting source and probing device are used to measure the output of the formed solar cell device by use of one or more automated components adapted to make electrical contact with terminals in the junction box 370. If the module detects a defect in the formed device it can take corrective actions or the solar cell can be scrapped.

Next the solar cell structure 304 is transported to the support structure module 241 in which support structure mounting steps 141 are performed on the solar cell structure 304 to provide a complete solar cell device that has one or more mounting elements attached to the solar cell structure 304 formed using steps 102-140 to a complete solar cell device that can easily be mounted and rapidly installed at a customer's site.

Next the solar cell structure 304 is transported to the unload module 242 in which step 142, or device unload steps are performed on the substrate to remove the formed solar cells from the solar cell production line 200.

In one embodiment of the solar cell production line 200, one or more regions in the production line are positioned in a clean room environment to reduce or prevent contamination from affecting the solar cell device yield and useable lifetime. In one embodiment, as shown in FIG. 2, a class 10,000 clean room space 250 is placed around the modules used to perform steps 108-118 and steps 130-134.

Referring to FIGS. 1 and 2, in one embodiment of the solar cell production line 200 one or more accumulators 211A-211D are inserted to provide buffering capability at various points within the solar cell production line 200 to achieve a desired throughput during steady state and fault state conditions (e.g., one or more modules 202-241 is in a fault state). As shown in FIG. 2, in one embodiment, the solar cell production line 200 has at least one accumulator 211 (e.g., accumulator 211A) positioned before the one or more cluster tools 212A-212D found in the processing module 212 and at least one accumulator 211 (e.g., accumulator 211B) positioned after the one or more cluster tools 212A-212D. During the production of solar cells it is generally desirable to load the accumulators 211A with two or more substrates to assure that the one or more cluster tools 212A-212D have a ready supply of substrates, and provide a collection area where substrates coming from the upstream processes can be stored if one or more of the cluster tools 212A-212D goes down.

### Lamination Module Design and Processes

As noted above, during step 134, or the lamination step, one or more process steps (e.g., a processing sequence 480 shown in FIG. 4B) are performed to bond the backside glass substrate 361 to the devices substrate 303 formed in steps 102-130 using a bonding material 360 to form a composite solar cell structure 304 (FIG. 3D). Step 134 is thus used to seal the active elements of the solar cell from the external environment to prevent the premature degradation of a formed solar cell during its useable life.

FIGS. 4A-4B illustrate one or more embodiments of a bonding module 234 which may be useful to perform the processing sequence 480, discussed below. FIG. 4A is a schematic cross-sectional view of the bonding module 234 that illustrates some of the common components found within this module. Generally, the bonding module 234 contains a preheat module 411, a lamination module 410, a system controller 420, and a conveyor system 422. The conveyor system 422 generally contains a plurality of supporting rollers 421 that are designed to support, move and/or position a composite solar cell structure 304, hereafter substrate “W”. As shown in FIG. 4A, a solar cell can be transferred into and through the bonding module 234 following the path A.

The system controller 420 is adapted to control the various components in the bonding module 234. In one embodiment, the system controller 420 may be connected to or be part of the system controller 290 of FIG. 2. The system controller 420 is generally designed to facilitate the control and automation of the overall bonding module 234 and typically includes a central processing unit (CPU) (not shown), memory (not shown), and support circuits (or I/O) (not shown). The CPU may be one of any form of computer processors that are used in industrial settings for controlling various system functions, chamber processes and support hardware (e.g., sensors, robots, motors, lamps, etc.) and monitor the processes (e.g., substrate support temperature, power supply variables, chamber process time, I/O signals, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 420 determines which tasks are performable on a substrate W. In one embodiment, the program is software readable by the system controller 420 that includes code to perform tasks relating to monitoring, execution and control of the movement, support, and/or positioning of a substrate along with the various process recipe tasks and various chamber process recipe steps being performed in the bonding module 234. In one configuration, the system controller 420 and/or system controller 290 comprise a memory, such as a RAM, a ROM, a hard disk, or any other form of digital storage medium, that is coupled to the system controller, wherein the memory comprises a computer-readable medium having a computer-readable program embodied therein for directing the operation of the preheat module and lamination module, the computer-readable program comprising computer instructions to control one or more parts of the preheat module and lamination module processes performed therein and discussed below in conjunction with FIG. 4B.

### Preheat Module

The preheat module 411 generally contains a plurality of supporting rollers 421, a plurality of heating elements 401A, 401B, two or more temperature sensors (e.g., temperature sensors 402A, 402B), and one or more compression rollers 431A. The plurality of supporting rollers 421 are adapted to support the substrate W while it is positioned within the processing region 415 of the preheat module 411 and are configured to withstand the temperatures created by the heating elements 401A, 401B during normal processing. In one configuration, the preheat module 411 has one or more walls 475 that enclose the processing region 415 so that the thermal environment formed therein can be controlled during the preheat process (step 481 in FIG. 4B). In one example, the plurality of supporting rollers 421 are configured to deliver and transfer a substrate W through an inlet port 471 formed in the one or more walls 475, the processing region 415 and out an exit port 472 formed in the one or more walls 475.

In one embodiment, the preheat module 411 also contains a fluid delivery system 440A that is use to deliver a desired flow of a fluid, such as air or nitrogen (N₂), through the processing region 415 during processing. In one embodiment, the fluid delivery system 440A contains a fan that is adapted to deliver a desired flow of air across one or more surfaces of the substrate disposed within the processing region 415 by use of commands from the system controller 420.

The plurality of heating elements 401A, 401B are typically lamps (e.g., IR lamps), resistive heating elements, or other heat generating devices that are controlled by the system controller 420 to deliver a desired amount of heat to desired regions of the substrate W during processing. In one embodiment, a plurality of heating elements 401A are positioned above the substrate W and a plurality of heating elements 401B are positioned below the substrate W. In general, the output of heating elements 401A, 401B may controlled by use of one or more thyristors, such as an SCR or SSR, connected to the system controller 420. In one embodiment, the heating elements 401A, 401B are tungsten lamp arc lamps that extends well past the edge of the substrate (e.g., lamps extend perpendicular to the page shown in FIG. 4A) to assure that delivered energy is uniform across the region of the preheat chamber that the individual lamp is configured to predominantly heat. In one embodiment, at least one of the heating elements 401A, 401B is adapted to deliver a uniform amount of energy across a substrate as it is continually moved through the processing region by the supporting rollers 421. In one embodiment, the heating elements 401A, 401B are oriented substantially perpendicular to the direction of travel of the substrate and the energy delivered by the lamps creates a uniform temperature profile across the substrate W as it is continually moved through the processing region.

In configurations where the one or more heating elements 401A-B are an IR type lamp or other similar device, typically when the power is decreased from 100% the amount of power delivered to the substrate will drops-off rapidly. Therefore, it is often desirable to deliver power to the one or more heating elements 401A-B at either 0% (i.e., Off) or at a 100% (i.e., On) of the maximum power to allow for a known heat flux to be delivered to the substrate at any instant in time. Therefore, to control the amount of heat delivered to the substrate the system controller 420 is also configured to adjust the duty cycle that the lamps are “on”, to control the delivered power over a desirable period of time.

The compression rollers 431A are adapted to provide a desired amount of force “F” to the substrate W (i.e., composite structure 460) to assure that all of the air bubbles found within the substrate W are removed and the bonding material within the substrate W is evenly distributed after performing the preheat process step. The compression rollers 431A are generally configured to receive the substrate W after it has been sufficiently heated in the preheat module 411. In one embodiment, as shown in FIG. 4A, a pair of compression rollers 431A are used to remove any trapped air from the substrate by applying a force F to both sides of the substrate W using a pair of compression rollers 431A that are urged by a conventional electric or a pneumatic force generating element.

Referring to FIG. 4A, the preheat module 411 also contains two temperatures sensors 402A, 402B that are adapted to measure the temperature of regions of the substrate W during the preheat process. The temperature sensors may be non-contact type temperature sensor, such as a conventional pyrometer, or a conventional contacting type of temperature sensor. In one embodiment, the temperature sensors are an optical type of temperature sensor. In one embodiment, the preheat module 411 contains a top temperature sensor 402A that is adapted to measure the temperature of the top of the substrate W and a bottom temperature sensor 402B that is adapted to measure the temperature of the bottom of the substrate W during or after processing. In one embodiment, the top temperature sensor 402A and a bottom temperature sensor 402B are positioned over one another so that the difference in temperature between the top side and bottom side of the substrate W at the same position on the substrate can be simultaneously measured. In one embodiment, an array of pairs of temperature sensors 402A, 402B are positioned over desired areas of the substrate W (e.g., into the page of FIG. 4A) so that top and bottom temperature readings at different areas of the substrate W can be measured.

### Lamination Module

The lamination module 410 generally contains a plurality of supporting rollers 421, a plurality of heating elements 401C, 401D, two or more temperature sensors (e.g., temperature sensors 402C, 402D), and one or more compression rollers 431B. The plurality of supporting rollers 421 are adapted to support the substrate W while it is positioned within the processing region 416 of the lamination module 410 and are configured to withstand the temperatures achieved during normal thermal processing. In one configuration, the lamination module 410 has one or more walls 476 that enclose the processing region 416 so that the thermal environment formed therein can be controlled during the lamination process (step 483 in FIG. 4B). In one example, the plurality of supporting rollers 421 are configured to deliver and transfer a substrate W through an inlet port 473 formed in the one or more walls 476, the processing region 416 and out an exit port 474 formed in the one or more walls 476. In one embodiment, the inlet port 473 is adjacently positioned to receive a substrate W exiting the exit port 472 of the preheat module 411 so that the heat loss between the preheat step (step 481) and lamination step (step 483) step is minimized.

In one embodiment, the lamination module 410 also contains a fluid delivery system 440B that is use to deliver a desired flow of a fluid through the processing region 416 during processing. In one embodiment, the fluid delivery system 440B is fan assembly that is adapted to deliver a desired flow of air across one or more surfaces of the substrate disposed within the processing region 416 by use of commands sent from the system controller 420.

The plurality of heating elements 401C, 401D are typically lamps (e.g., IR lamps), resistive heating elements, or other heat generating devices that are controlled by the system controller 420 to deliver a desired amount of heat to desired regions of the substrate W during processing. In one embodiment, a plurality of heating elements 401C are positioned above the substrate W and a plurality of heating elements 401D are positioned below the substrate W. In general, the output of heating elements 401C, 401D may controlled by use of one or more thyristors, such as an SCR or SSR, connected to the system controller 420. In one embodiment, the heating elements 401C, 401D are tungsten lamp arc lamps that extends well past the edge of the substrate to assure that delivered energy is uniform across the region of the preheat chamber that the individual lamp is configured to predominantly heat. In one embodiment, at least one of the heating elements 401A, 401B is adapted to deliver a uniform amount of energy across a substrate as it is continually moved through the processing region by the supporting rollers 421. In one embodiment, the heating elements 401C, 401D are oriented substantially perpendicular to the direction of travel of the substrate and the energy delivered by the lamps creates a uniform temperature profile across the substrate as it is moved through the processing region.

In configurations where the one or more heating elements 401C-D are an IR type lamp or other similar device, typically when the power is decreased from 100% the amount of power delivered to the substrate will drops-off rapidly. Therefore, it is often desirable to deliver power to the one or more heating elements 401C-D at either 0% (i.e., Off) or at a 100% (i.e., On) of the maximum power to allow for a known heat flux to be delivered to the substrate at any instant in time. Therefore, to control the amount of heat delivered to the substrate the system controller 420 is also configured to adjust the duty cycle that the lamps are “on”, to control the delivered power over a desirable period of time.

The one or more compression rollers 431B are adapted to provide a desired amount of force “F” to the substrate W (i.e., composite solar cell structure 304) to assure that all of the air bubbles found within the substrate W are removed and the bonding material 360 within the substrate W is evenly distributed. The compression rollers 431B are generally configured to receive the substrate W after it has been sufficiently heated in the lamination module 410. In one embodiment, as shown in FIG. 4A, a pair of compression rollers 431B are used to remove any trapped air from the substrate by apply a force F to both sides of the substrate W by the compression rollers 431B by use of a conventional electric or pneumatic force generating element.

Referring to FIG. 4A, the lamination module 410 also contains two temperatures sensors 402C, 402D that are adapted to measure the temperature of regions of the substrate W during the lamination process. The temperature sensors may be non-contact type temperature sensor, such as a conventional pyrometer, or a conventional contact type temperature sensor. In one embodiment, the temperature sensors are optical type temperature sensors. In one embodiment, the lamination module 410 contains a top temperature sensor 402C that is adapted to measure the temperature of the top of the substrate W and a bottom temperature sensor 402D that is adapted to measure the temperature of the bottom of the substrate W during or after processing. In one embodiment, the top temperature sensor 402C and a bottom temperature sensor 402D are positioned one over another so that the difference in temperature between the top side and bottom side of the substrate W can be simultaneously measured. In one embodiment, an array of pairs of temperature sensors 402C, 402D are positioned over desired areas of the substrate W so that top and bottom temperature readings at different areas of the substrate W can be measured.

### Lamination Process Sequence

Referring to FIGS. 1, 3C-3D, and 4A-4B, in step 134 a series of sub-sequence steps, or processing sequence 480, are used to complete perform the lamination process. As discussed above, embodiments of the invention may include a method and a device for laminating the solar cell to isolate the active elements of the solar cell from the external environment. FIG. 4B illustrates one embodiment of a process sequence 480 that contains a plurality of steps (i.e., steps 482-492) that are used to form a solar cell device. In general, the processing sequence 480 can be divided up into two main process steps, which are the preheat step 481 and the lamination step 483. The configuration of the processing sequence, number of processing steps, and order of the processing steps in the process sequence 480 illustrated herein are not intended to be limiting to the scope of the invention described herein.

The process sequence 480 generally starts at step 482 in which one or more substrates W are moved to the input of the preheat module 411 of the bonding module 234 using the supporting rollers 421, discussed above. The supporting rollers 421 can be adapted to receive a plurality of substrates W that have been processed following steps 102-132 and can be controlled by the system controller 420. Movement of the substrates W can be controlled by commands sent to one or more driving mechanism coupled to the supporting rollers 421 from the system controller 420.

In the next step, step 484, the substrate W controllably heated as it passes through the processing region 415 by use of the one more of the heating elements 401A, 401B disposed therein. In one embodiment, at least one of the top heating elements 401A and at least one of the bottom heating elements 401B are close loop controlled using the system controller 420 and at least one temperature sensor positioned on the top of the substrate (e.g., top temperature sensor 402A) and at least one temperature sensor positioned on the bottom of the substrate (e.g., bottom temperature sensor 402B). In this configuration the temperature of the substrate W closest to the heating elements 401A can be close loop controlled by use of the temperature sensor 402A and power delivered by the system controller 420, and the temperature of the substrate W closest to the heating elements 401B can be close loop controlled by use of the temperature sensor 402B and power delivered by components within the system controller 420.

In one embodiment of step 484, the system controller 420 is configured to measure the temperature of the substrate W at multiple points along its length of the substrate W to more accurately monitor the temperature variation across the substrate so that the temperature uniformity can be improved. In one embodiment, the temperature is measured and monitored at defined increments as the substrate W is moved past a temperature sensor using the supporting rollers 421 that are both monitored and controlled by the system controller 420. In one embodiment, the substrate W temperature is measured using a user defined number of odd or even numbered increments that are used by the system controller 420 to divide up the substrate to form a number of equally spaced temperature measurement intervals. In one embodiment, it is desirable to only use even numbered increments, since it will divide the substrate into a odd number of equally spaced intervals (e.g., 2 increments will divide up into 3 intervals).

In one embodiment, to control the temperature uniformity across one or more of the substrates W passing through the preheat module 411 the controller 420 monitors and stores multiple temperature measurements to create a rolling average that is used to more accurately control the preheat process (e.g., step 481 in FIG. 4B). The rolling average may be created by selecting a first number of temperature measurement points that are to be measured on a single substrate and a second number of temperature measurement points over which the rolling average will be created. Using a rolling average over multiple measurement points across a substrate will help improve the process control and tend damp any fluctuation in the preheat process.

In one embodiment of step 484, one top heating element 401A and one bottom heating element 401B in a central position “C” (as shown in FIG. 4A) are controlled independently by use of thrystors found in the system controller 420 and the other remaining heating elements 401A, 401B are either configured to be run at one fixed power level in a range between 0% and 100% of full power. In this configuration the system controller 420 is adapted to control the temperature of the substrate W as it passes through the preheat module 411 by controlling at least one top heating element 401A and at least one bottom heating element 401B, using the data received from the top temperature sensor 402A and a bottom temperature sensor 402B.

In another embodiment of step 484, at least one of the top heating elements 401A and at least one of the bottom heating elements 401B are individually controlled by use of thrystors found in the system controller 420 and at least one of the top heating elements 401A and/or at least one of bottom heating elements 401B are either in an “on” state (i.e., 100% of full power) or an “off” state (i.e., 0% of full power). In this configuration the system controller can optionally turn “on” or turn “off” one or more of the heating elements 401A, 401B based on the temperature measurements received by the one or more of the top temperature sensors 402A and the one or more bottom temperature sensors 402B. In one embodiment, in which the bonding material is a PVB the preheat module temperature set point may be in a range between about 40° C. and about 60° C.

In one embodiment of step 484, a flow of fluid through the processing region 415 is also controlled in conjunction with the power delivered to one or more of the heating elements 401A, 401B to provide a uniform temperature profile across the substrate. In one embodiment, the speed of a fan or blower in the fluid delivery system 440 is controlled to provide a desired flow on either side, or both sides, of the substrate W as the substrate moves through the processing region 415.

In the next step, step 486, a desired force is applied one or more sides of the preheated substrate by use of the one or more compression rollers 431A using one or more controlled force generating elements. The applied force supplied by the one or more compression rollers 431A may be between about 200 [N/cm] and about 600 [N/cm].

In the next step, step 488, one or more substrates W are moved to the input of the lamination module 410 of the bonding module 234 using the supporting rollers 421, discussed above. The supporting rollers 421 can be adapted to receive a plurality of substrates W from the preheat module and control their movement by commands sent to one or more driving mechanism coupled to the supporting rollers 421 from the system controller 420.

In the next step, step 490, the substrate W controllably heated as it passes through the processing region 416 by use of the one more of the heating elements 401C, 401D disposed therein. In one embodiment, at least one of the top heating elements 401C and at least one of the bottom heating elements 401D are close loop controlled using the system controller 420 and at least one temperature sensor positioned on the top of the substrate (e.g., top temperature sensor 402C) and at least one temperature sensor positioned on the bottom of the substrate (e.g., bottom temperature sensor 402D).

In one embodiment of step 490, the system controller 420 is configured to measure the temperature of the substrate W at multiple points along its length of the substrate W to more accurately monitor the temperature variation across the substrate so that the temperature uniformity during the lamination step 483 can be more effectively controlled. In one embodiment, the temperature is measured and monitored at defined increments as the substrate W is moved past a temperature sensor using the supporting rollers 421 that are both monitored and controlled by the system controller 420. In one embodiment, the substrate W temperature is measured using a user defined number of odd or even numbered increments that are used by the system controller 420 to divide up the substrate to form a number of equally spaced temperature measurement intervals. In one embodiment, it is desirable to only use even numbered increments, since it will divide the substrate into an odd number of equally spaced intervals.

In one embodiment, to control the temperature uniformity across one or more of the substrates passing through the lamination module 410 the controller 420 monitors and stores multiple temperature measurements to create a rolling average that is used to more accurately control the lamination process (e.g., step 483 in FIG. 4B). Using a rolling average over multiple measurement points across the substrate will help improve the process control and tend damp any fluctuation in the temperature control process.

In one embodiment of step 490, one top heating element 401C and one bottom heating element 401D in a central position “C” (as shown in FIG. 4A) are controlled independently by use of thrystors found in the system controller 420 and the other remaining heating elements 401C, 401D are either configured to be run at one fixed power level in a range between 0% and 100% of full power. In this configuration the system controller 420 is adapted to control the temperature of the substrate W as it passes through the lamination module 410 by controlling the one top heating element 401C and the one bottom heating element 401D, using the data received from the top temperature sensor 402C and a bottom temperature sensor 402D.

In another embodiment of step 490, at least one of the top heating elements 401C and at least one of the bottom heating elements 401D are individually controlled by use of thrystors found in the system controller 420 and at least one of the top heating elements 401C and/or at least one of the bottom heating elements 401D are either in an “on” state (i.e., 100% of full power) or an “off” state (i.e., 0% of full power). In this configuration the system controller can optionally turn “on” or turn “off” one or more of the heating elements 401C, 401D based on the temperature measurements received by the one or more of the top temperature sensors 402C and the one or more bottom temperature sensors 402D. In one embodiment, in which the bonding material is a PVB the lamination module temperature set point may be in a range between about 70° C. and about 105° C.

In one embodiment of step 490, a flow of fluid through the processing region 416 is also controlled in conjunction with the power delivered to one or more of the heating elements 401C, 401D to provide a uniform temperature profile across the substrate. In one embodiment, the speed of a fan or blower in the fluid delivery system 440B is controlled to provide a desired flow on either side, or both sides, of the substrate W as the substrate moves through the processing region 416.

In the next step, step 492, the a desired force is applied one or more sides of the preheated substrate by use of the one or more compression rollers 431B that using one or more controlled force generating elements. The applied force supplied by the one or more compression rollers 431A may be between about 200 [N/cm] and about 600 [N/cm]. After completion of this process sequence 480 the solar cell device is transferred to the autoclave module 236 where step 136 can be performed.

While the foregoing is directed to embodiments of the present invention, other and further embodiments of the invention may be devised without departing from the basic scope thereof, and the scope thereof is determined by the claims that follow.

What is claimed is:

1. An apparatus for bonding a composite solar cell structure, comprising:
a conveyer system configured to transfer and support the composite solar cell structure;
a preheat module disposed along the conveyer system, wherein the preheat module is configured to receive the composite solar cell structure from the conveyer system and to heat the composite solar cell structure to a desired temperature, wherein the preheat module comprises:
a plurality of supporting rollers configured to support and transfer the composite solar cell structure through a preheat processing region;
one or more top preheat heating elements disposed over the plurality of supporting rollers and configured to heat an upper side of the composite solar cell structure disposed on the plurality of supporting rollers;
one or more bottom preheat heating elements disposed under the plurality of supporting rollers and configured to heat a lower side of the composite solar cell structure disposed on the plurality of supporting rollers;
one or more top preheat temperature sensors disposed over the plurality of supporting rollers and is adapted to measure the temperature of the composite solar cell structure as it is transferred through the through a processing region;
one or more bottom preheat temperature sensors disposed under the plurality of supporting rollers and is adapted to measure the temperature of the composite solar cell structure as it is transferred through the through the processing region; and
a pair of compression rollers configured to apply a force to the composite solar cell structure from opposite sides;
a lamination module disposed along the conveyer system, wherein the lamination module is configured to receive the composite solar cell structure from the conveyer system and to bond the composite solar cell structure by heating, wherein the lamination module comprises:
a plurality of supporting rollers configured to support and transfer the composite solar cell structure through a lamination processing region;
one or more top lamination heating elements disposed over the plurality of supporting rollers and configured to heat an upper side of the composite solar cell structure disposed on the plurality of supporting rollers;
one or more bottom lamination heating elements disposed under the plurality of supporting rollers and configured to heat a lower side of the composite solar cell structure disposed on the plurality of supporting rollers;
one or more top lamination temperature sensors disposed over the plurality of supporting rollers and is adapted to measure the temperature of the composite solar cell structure as it is transferred through the through a processing region;
one or more bottom lamination temperature sensors disposed under the plurality of supporting rollers and is adapted to measure the temperature of the composite solar cell structure as it is transferred through the through the lamination processing region; and
a pair of compression rollers configured to apply a force to the composite solar cell structure from opposite sides; and
a system controller that is configured to receive a signal from the one or more top preheat temperature sensors, the one or more bottom preheat temperature sensors, the one or more top lamination temperature sensors, and the one or more bottom lamination temperature sensors, and adjust the power delivered to the one or more top preheat heating elements, the one or more bottom preheat heating elements, the one or more top lamination heating elements, and the one or more bottom lamination heating elements based on the received signals.

2. The apparatus of claim 1, wherein the conveyer system comprises a plurality of supporting rollers configured to transfer the composite solar cell structure along a linear path that enters the preheat module, exits the preheat module, enters the lamination module, then exits the lamination module.

3. The apparatus of claim 1, wherein
the preheat module comprises one or more walls that enclose the preheat processing region, and an exit port formed in the one or more walls, and
the lamination module comprises one or more walls that enclose the lamination processing region, and an inlet port formed in the one or more walls,
wherein the exit port is positioned adjacent to the inlet port.

4. The apparatus of claim 3, wherein the one or more top heating elements and the one or more bottom heating elements in the preheat module and the lamination module are an infrared lamp or a resistive heating element controlled by the system controller.

5. The apparatus of claim 4, wherein the system controller is configured to adjust a duty cycle of the one or more top heating elements and the one or more bottom heating elements.

6. The apparatus of claim 4, wherein at least one of the one or more top heating elements is independently controlled, and at least one of the one or more bottom heating elements is independently controlled.

7. The apparatus of claim 4, wherein the at least one of the one or more top heating elements and the at least one of the one or more bottom heating elements are controlled by using one or more thyristors.

8. The apparatus of claim 4, wherein each of the preheat module and the lamination module further comprises:
one or more temperature sensors configured to measure temperature of the composite solar cell structure, wherein the one or more temperature sensors are connected to the system controller which is configured to control at least one of the one or more top heating element and the one or more bottom heating elements.

9. The apparatus of claim 8, wherein the one or more temperature sensors comprises an upper temperature sensor configured to measure the temperature at the upper side of the composite solar cell structure; and a lower temperature sensor configured to measure the temperature at the lower side of the composite solar cell structure.

10. The apparatus of claim 3, wherein each of the preheat module and the lamination module further comprises: a fluid delivery system configured to deliver a desired flow of a fluid to the processing region.

11. The apparatus of claim 10, wherein the fluid delivery system comprises a fan adapted to deliver a desired flow of air across one or more surfaces of the composite solar cell structure in the processing region.

12. A method for forming solar cells, comprising:
preparing composite solar cell structures, wherein preparing composite solar cell structure comprises:
placing a bonding material over a device substrate having solar cell devices formed thereon; and
placing a back glass substrate over the bonding material and the device substrate;
moving the composite solar cell structures sequentially through a processing region of a preheat module while preheating the composite solar cell structures in the processing region, wherein preheating the composite solar cell structures in the preheating module comprises actively controlling temperature of the composite solar cell structures; and
applying a force to the composite solar cell structures to distribute the bonding material between each back glass substrate and the corresponding device substrate; and
moving the composite solar cell structures through a processing region of a lamination module while bonding each back glass substrate to the corresponding device substrate, wherein bonding each back glass substrate to the corresponding device substrate comprises actively controlling temperature of the composite solar cell structures.

13. The method of claim 12, wherein actively controlling temperature of the composite solar cell structures in preheating and bonding the composite solar structures comprises:
heating the composite solar cell structures using one or more top heating element disposed in processing region over the composite solar cell structure and one or more bottom heating element disposed in the processing region under the composite solar cell structure;
monitoring temperature of the composite solar cell structure closest to the one or more top heating elements and one or more bottom heating element; and
adjusting power delivered to at least one of the one or more top heating elements or the one or more bottom heating elements.

14. The method of claim 13, wherein monitoring temperature of the composite solar cell structure comprises measuring the temperature of the composite solar cell structure at multiple points along its length.

15. The method of claim 13, wherein monitoring temperature of the composite solar cell structure comprises:
monitoring and storing multiple temperature measurements; and
creating a rolling average from the multiple temperature measurements.

16. The method of claim 13, wherein adjusting the power delivered to the at least one of the one or more top heating elements or the one or more bottom heating elements comprises independently controlling a top heating element in a central position and a bottom heating element in a central position by using thrystors.

17. The method of claim 13, wherein adjusting the power delivered to the at least one of the one or more top heating elements or the one or more bottom heating elements comprises controlling a duty cycle of the at least one heating elements.

18. The method of claim 13, wherein actively controlling temperature of the composite solar cell structures further comprises delivering a flow of fluid to the processing regions of the preheat module and the lamination region.

19. The method of claim 12, further comprising applying a compressive force to the composite solar cell structure after moving the composite solar cell structure through the processing region of the lamination module.

20. The method of claim 12, wherein the compressive force is applied using a pair of compression rollers.

21. The method of claim 20, wherein the compressive force from the pair of compression rollers is between about 200 N per centimeter to about 600 N per centimeter.

22. The method of claim 12, wherein preheating the composite solar cell structures comprises setting a preheating temperature of the preheat module in a range between about 40° C. to about 60° C.

23. The method of claim 20, wherein bonding each back glass substrate to the corresponding device substrate comprises setting a bonding temperature of the lamination module in a range between about 70° C. to about 105° C.
